(19) United States
(12) Patent Application Publication
(10) Pub. No.: US 2023/0421368 A1
(43) Pub. Date: Dec. 28, 2023

(54) SMART CHIP ENABLED ONE-TIME PASSWORD RESOURCE DISTRIBUTION CARD

(71) Applicant: BANK OF AMERICA CORPORATION, Charlotte, NC (US)

(72) Inventor: Vishal Dnyandeo Patil, Concord, NC (US)

(73) Assignee: BANK OF AMERICA CORPORATION, Charlotte, NC (US)

(21) Appl. No.: 17/847,947

(22) Filed: Jun. 23, 2022

(51) Int. Cl. H04L 9/08; H04L 9/00; H04L 9/32

(52) U.S. Cl. CPC H04L 9/0863; H04L 9/0869; H04L 9/50; H04L 9/321

(57) ABSTRACT

A resource distribution card device that includes a microprocessor (i.e., smart chip) that is capable of generating a One Time Passcode (OTP). The resource distribution card acts as a hardware token that is capable of generating an OTP. An OTP application stored within the memory of the microprocessor receives a signal that notifies of an occurrence of a predetermined triggering event and, in response to receiving the signal, generates an OTP, which is either simultaneously generated at a backend computing platform via time-based synchronization or indirectly communicated to the backend computing platform, which communicates the OTP to the user and performs requisite verification as part of a multi-factor user authentication process.

### FIELD OF THE INVENTION

The present invention is multi-factor user authentication and, more specifically, providing for resource distribution card device having an embedded microprocessor (i.e., smart chip) that is capable of generating a One-Time-Password (OTP) that is used as part of multi-factor user authentication process.

### BACKGROUND

One-Time Passwords (OTPs) are commonly used in many multi-factor user authentication scenarios. For example, a user may input user credentials (e.g., username, passcode or the like) and, in response, an OTP is generated, stored and communicated to a user, who must present the OTP. If the OTP presented by the user matches the OTP that is stored, the user is deemed to authenticated.

An OTP may be generated by a software token or a hardware token. A software token is an authentication token that is not physically tangible, but instead exists as software on common computing devices, such as computers, smart phones and the like. A hardware token is a physical device, typically a standalone device, such as an OTP key fob/card device or the like. While software tokens are becoming more prevalent, due to the fact that they do not require the user to possess separate device, hardware tokens are still prevalent, since they offer additional security features.

Therefore, a need exists to develop devices, methods, computer program products and the like which generate an OTP in a hardware token, without requiring a user to possess a standalone hardware device, such as an OTP key/card or the like.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a resource distribution card device that includes a microprocessor (i.e., smart chip) that is capable of generating a One Time Passcode (OTP). For example, the microprocessor may store and execute one or more Random Number Generator (RNG) or Pseudo-Random Number Generator (PRNG) algorithms. In this regard, the resource distribution card acts as a hardware token that is capable of generating an OTP. As a result, since a resource distribution card device is a physical object that is commonly in possession of a user, the user is not required to possess a standalone hardware token, such as OTP key fob/card or the like for purposes of OTP generation.

According to specific embodiments of the invention, the OTP generator on the resource distribution card device is time-synchronized with a backend computing platform (i.e., authentication server), meaning that the clock mechanism in the resource distribution card device is synchronized to the exact same time base in the backend computing platform. This means that when an OTP is generated on the resource distribution card device, the same OTP is simultaneously generated at the backend computing platform and is valid for a short period of time (e.g., sixty seconds or less). Since the resource distribution card device is pre-registered with the backend computing platform, the backend computing platform knows which user is associated with the resource distribution card device and the user's chosen communication identifier (i.e., telephone number, email address or the like). As a result, once the OTP is generated, the backend computing platform can communicate the OTP to the user and subsequently compare the OTP inputted by the user to the current OTP as a means of authenticating the user.

In other embodiments of the invention, in which the resource distribution card is not synchronized with the authentication card, the OTP generator on the resource distribution card device may initiate indirect communication of the OTP to a backend computing platform. Since the microprocessor in the resource distribution card is a passive device and, thus not suitable, for electronic communication transmission, the resource distribution card device would need to be in communication with an active device capable of electronic communication transmission in order to communicate the OTP to the backend-computing platform. Similar to the synchronization embodiments, the resource distribution card device is required to be pre-registered with the backend computing platform, such, that, the backend computing platform knows which user is associated with the resource distribution card device and the user's chosen communication identifier (i.e., telephone number, email address or the like). As a result, once the OTP is generated and communicated to the backend computing platform, the backend computing platform can store the OTP, communicate the OTP to the user and subsequently compare the OTP inputted by the user to the stored OTP as a means of authenticating the user.

In other embodiments of the invention, in which the embedded microprocessor is additionally equipped with a Near-Field Communication (NFC) mechanism, the resource distribution card device may directly communicate the OTP from the resource communication card device to a user device equipped with an NFC reader (e.g., mobile/smart telephone or the like) NFC Data Exchange Format (NDEF) message.

According to embodiments of the invention, the embedded microprocessor of the resource distribution card device receives a signal that notifies of an occurrence of a triggering event (i.e., an event that results in generation of an OTP). The triggering event may include, but is not limited to, (i) reading at least a portion of the resource distribution information stored in the memory of the microprocessor, (ii) using the resource distribution card to initiate a resource distribution event that is determined to deviate from a known user baseline for resource distribution events, and (iii) verification of user inputted user credentials.

A resource distribution card device for initiating multi-factor user authentication, defines first embodiments of the invention. The card device includes an embedded microprocessor (i.e., smart chip) that includes a memory. The memory stores resource distribution information associated with a user and a One-Time Password (OTP) application that is executable by the microprocessor and configured to receive a signal that notifies of an occurrence of a predetermined triggering event, and, in response to receiving the signal, generate an OTP. The OTP is used as part of a multi-factor authentication of the user.

In specific embodiments of the card device, the OTP application stored within the memory of the embedded microprocessor includes at least one Random Number Generator (RNG) algorithm or Pseudo Random Number Generator (PRNG) configured to, in response to receiving the signal, generate the OTP.

In specific embodiments of the card device, the resource distribution card device is preregistered with an OTP module executing on a backend computing device (e.g., network server, cloud-based, VPN or the like). Preregistering includes associating the user of the card device and at least one user communication identifier (e.g., telephone number, email address or the like) with the OTP application executing on the resource distribution card. In such embodiments, the OTP application is synchronized with the OTP module for purposes of OTP generation, such that when an OTP generated at the resource distribution card device at a specified time the same OTP at the backend computing platform is generated and valid for authentication purposes for a predetermined time period (e.g., 60 seconds or the like).

In other specific embodiments of the card device, the OTP application is configured to initiate indirect communication (e.g., via a communication network-accessible device that is communication with resource distribution card device) of the OTP to an OTP module executing on a back-end computing platform. In such embodiments the OTP module, in receipt of the OTP, is configured to store an association between the OTP and at least one of the (i) user, and (ii) a pre-registered user communication identifier (e.g., telephone number, email address or the like) and, in further specific embodiments, communicate the OTP to the user (i.e., text to a user device, email to a user email account) based on the pre-registered user communication identifier.

In further specific embodiments of the card device, the predetermined triggering event that prompts the signal is the reading of, at least a portion of, the resource distribution information stored in the memory. For example, in specific embodiments of the card device, the embedded microprocessor includes a Near Field Communication (NFC) mechanism, and the predetermined triggering event is activating the NFC mechanism to transmit the resource distribution information stored in the memory to an NFC reader.

In other embodiments of card device, the predetermined triggering event is a resource distribution event initiated by the resource distribution card that is determined to deviate from a known user baseline for resource distribution events. For example, in specific embodiments of the card device the known user baseline is based on at least one of (i) amount of the resource distribution event, (ii) location of the resource distribution event and (iii) time of the resource distribution event.

In other embodiments of card device, the predetermined triggering event is verification of user credentials provided by the user (e.g., username/passcode, biometric data or the like). In such embodiments the card device may further include a fingerprint sensor embedded in the card device and the microprocessor may further include a fingerprint detection application configured to receive a fingerprint impression from the fingerprint sensor and determine that the fingerprint impression matches a prestored fingerprint impression of the user.

In further specific embodiments of the card device, the card device further includes a display, in communication with the embedded microprocessor, that is configured to, in response to generating the OTP, display the OTP. In related embodiments of the card device, the embedded microprocessor further includes a Near Field Communication (NFC) mechanism. In such embodiments, the OTP application is further configured to directly communicate the generated OTP from the resource distribution card device to a user device associated with the user and that is equipped with an NFC reader via an NFC Data Exchange Format (NDEF) message.

In further specific embodiments of the card device, the OTP application or, in some embodiments, the OTP module executing on a back-end computing platform communicates the OTP to a distributed trust computing network that includes a plurality of decentralized nodes, and, in response to receiving the OTP, a plurality of the decentralized nodes are configured to verify an authenticity of the OTP and, in response, store the OTP and user association data as a data block within a distributed ledger stored within or accessible to the distributed trust computing network.

A computer-implemented method for initiating multi-factor user authentication defines second embodiments of the invention. The computer-implemented method is executable by one or more computing processor devices. The method includes receiving, at a microprocessor embedded in a resource distribution card device, a signal that notifies of an occurrence of a predetermined triggering event and, in response to receiving the signal, generating, by the microprocessor, a One-Time Password (OTP). The OTP is used as part of a multi-factor authentication of the user.

In specific embodiments the computer-implemented method further comprises initiating indirect transmission of the OTP to a back-end computing platform. In response to receiving the OTP at the back-end-computing platform, the computer-implemented method further includes storing an association between the OTP and at least one of the (i) user, and (ii) a pre-registered user communication identifier (e.g., telephone number, email address). In addition, the computer-implemented method includes communicating the OTP from the back-end computing platform to the user (e.g., text message to a user device or email to a user email account) based on the pre-registered user communication identifier.

In other specific embodiments of the computer-implemented method, the resource distribution card device is pre-registered with an OTP module executing on a backend-computing platform. Pre-registering includes associating the user and at least one user communication identifier with the OTP application of the resource distribution card device. In such embodiments of the computer-implemented method, OTP application is synchronized with an OTP module for purposes of OTP generation, such that when an OTP generated at the resource distribution card device at a specified time the same OTP at the backend computing platform is generated and valid for authentication purposes for a predetermined time period (e.g., 60 seconds or the like).

In still further specific embodiments of the computer-implemented method, the predetermined triggering event is selected from the group consisting of (i) reading at least a portion of the resource distribution information stored in the memory, (ii) using the resource distribution card to initiate a resource distribution event that is determined to deviate from a known user baseline for resource distribution events, and (iii) verification of user inputted user credentials.

A computer program product including a non-transitory computer-readable medium defines third embodiments of the invention. The computer-readable medium includes a first set of codes for causing a microprocessor embedded in a resource distribution card device to receive a signal that notifies of an occurrence of a predetermined triggering event. The computer-readable medium additionally includes a second set of codes for causing the microprocessor embedded in the resource distribution card to generate a One-Time Password (OTP). The OTP is used as part of a multi-factor authentication of the user.

In specific embodiments of the computer program product, the computer-readable medium additionally includes a third set of codes for causing the microprocessor to initiate indirect transmission of the OTP to a back-end computing platform. Further, the computer-readable medium includes a fourth set of codes for causing a computing device to, in response to receiving the OTP at the back-end-computing platform, storing an association between the OTP and at least one of the (i) user, and (ii) a pre-registered user communication identifier. Moreover, the computer-readable medium includes a fifth set of codes for causing a computing device to communicate the OTP from the back-end computing platform to the user based on the pre-registered user communication identifier.

In other specific embodiments of the computer program product, the resource distribution card device is preregistered with an OTP module executing on a backend computing device (e.g., network server, cloud-based, VPN or the like). Preregistering includes associating the user of the card device and at least one user communication identifier (e.g., telephone number, email address or the like) with the OTP application executing on the resource distribution card. In such embodiments, the OTP application is synchronized with the OTP module for purposes of OTP generation, such that when an OTP generated at the resource distribution card device at a specified time the same OTP at the backend computing platform is generated and valid for authentication purposes for a predetermined time period (e.g., 60 seconds or the like).

Thus, according to embodiments of the invention, which will be discussed in greater detail below, the present invention provides for a resource distribution card device that includes a microprocessor (i.e., smart chip) that is capable of generating a One Time Passcode (OTP). In this regard, the resource distribution card acts as a hardware token that is capable of generating an OTP. As a result, since a resource distribution card device is a physical object that is commonly in possession of a user, the user is not required to possess a standalone hardware token, such as OTP key fob/card or the like for OTP generation purposes.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a resource distribution card device configured for generating a One-Time Password (OTP), in accordance with embodiments of the present invention;

FIG. 2 is a schematic system for synchronized generation of an OTP between a resource distribution card device and a backend computing platform, in accordance with some embodiments of the present disclosure;

FIG. 3 is a schematic diagram of a system for generating an OTP at resource distribution card device and indirectly communicating the OTP to a backend computing platform, in accordance with some embodiments of the present disclosure;

FIG. 4 is block diagram of a system for generating an OTP at resource distribution card device including distributed trust computing network authentication, in accordance with some embodiments of the present disclosure

FIG. 5 is a schematic diagram of a distributed trust computing network used to verify authenticity of OTPs generated at resource distribution card devices; in accordance with embodiments of the present invention;

FIG. 6 is block diagram of a resource distribution card device configured for generating an OTP, in accordance with embodiments of the present invention; and

FIG. 7 is flow diagram of a computer-implemented method for generating an OTP on resource distribution card device; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted, or unscripted programming language such as JAVA, PERL, SMALLTALK, C++, PYTHON, or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform may include a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

As used herein, “resource distribution card device” generally refers to a payment card, such as a credit or debit card and, more specifically a payment card with an embedded microprocessor/smart chip. Additionally, as used herein, “resource distribution information” associated with the user generally refers to a user's payment credentials, such as user identifier, payment account identifier or the like, which is stored in the memory of the microprocessor/smart chip.

Thus, systems, apparatus, and methods are described in detail below that provide for a resource distribution card device that includes a microprocessor (i.e., smart chip) that is capable of generating a One Time Password (OTP). For example, the microprocessor may store and execute one or more Random Number Generator (RNG) or Pseudo-Random Number Generator (PRNG) algorithms. In this regard, the resource distribution card acts as a hardware token that is capable of generating an OTP. As a result, since a resource distribution card device is a physical object that is commonly in possession of a user, the user is not required to possess a standalone hardware token, such as OTP key fob/card or the like for purposes of OTP generation.

According to specific embodiments of the invention, the OTP generator on the resource distribution card device is time-synchronized with a backend computing platform (i.e., authentication server), meaning that the clock mechanism in the resource distribution card device is synchronized to the exact same time base in the backend computing platform. This means that when an OTP is generated on the resource distribution card device, the same OTP is simultaneously generated at the backend computing platform and is valid for a short period of time (e.g., sixty seconds or less). Since the resource distribution card device is pre-registered with the backend computing platform, the backend computing platform knows which user is associated with the resource distribution card device and the user's chosen communication identifier (i.e., telephone number, email address or the like). As a result, once the OTP is generated, the backend computing platform can communicate the OTP to the user and subsequently compare the OTP inputted by the user to the current OTP as a means of authenticating the user.

In other embodiments of the invention, in which the resource distribution card is not synchronized with the authentication card, the OTP generator on the resource distribution card device may initiate indirect communication of the OTP to a backend computing platform. Since the microprocessor in the resource distribution card is a passive device and, thus not suitable, for electronic communication transmission, the resource distribution card device would need to be in communication with an active device capable of electronic communication transmission in order to communicate the OTP to the backend-computing platform. Similar to the synchronization embodiments, the resource distribution card device is required to be pre-registered with the backend computing platform, such, that, the backend computing platform knows which user is associated with the resource distribution card device and the user's chosen communication identifier (i.e., telephone number, email address or the like). As a result, once the OTP is generated and communicated to the backend computing platform, the backend computing platform can store the OTP, communicate the OTP to the user and subsequently compare the OTP inputted by the user to the stored OTP as a means of authenticating the user.

In other embodiments of the invention, in which the embedded microprocessor is additionally equipped with a Near-Field Communication (NFC) mechanism, the resource distribution card device may directly communicate the OTP from the resource communication card device to a user device equipped with an NFC reader (e.g., mobile/smart telephone or the like) NFC Data Exchange Format (NDEF) message.

According to embodiments of the invention, the embedded microprocessor of the resource distribution card device receives a signal that notifies of an occurrence of a triggering event (i.e., an event that results in generation of an OTP). The triggering event may include, but is not limited to, (i) reading at least a portion of the resource distribution information stored in the memory of the microprocessor, (ii) using the resource distribution card to initiate a resource distribution event that is determined to deviate from a known user baseline for resource distribution events, and (iii) verification of user inputted user credentials.

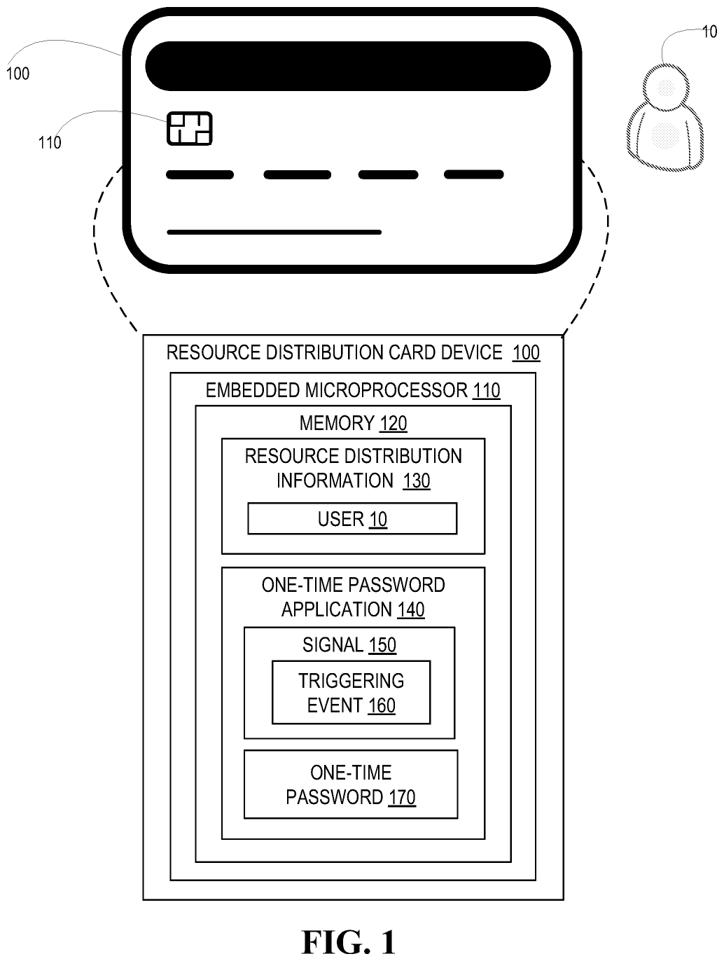

Referring to FIG. 1, shown is a resource distribution card device 100 configured to generate a One-Time Password (OTP); in accordance with embodiments of the present invention. Resource distribution card device 100 is of standard card-size, typically about 3⅜ inches×2 1/18 inches. Resource distribution card device 100 includes an embedded microprocessor 110, otherwise referred to as a “smart chip, “microcontroller” or the like. Microprocessor 110 includes memory 120 that stores resource distribution information 130 associated with a card device user 10. Resource distribution information 130 is read from the memory 120 for purposes of identifying the user 10 and the resources required to perform an associated resource distribution event for the user 10.

Memory 120 additionally stores one-time password application 140 that is configured to receive a signal 150 that notifies of an occurrence of a predetermined triggering event 160 and, in response, generate a one-time-password 170. The OTP 170 may be any numeric, alphanumeric code and/or word(s) that is configured for single use (i.e., one-time only use). In specific embodiments of the invention, the OTP is a numeric number and is generated using a Random Number Generator (RNG) algorithm(s) or a Pseudo-Random Number Generator (PRNG) or the like. The generated OTP is used for purposes of a multi-factor authentication of the user 10.

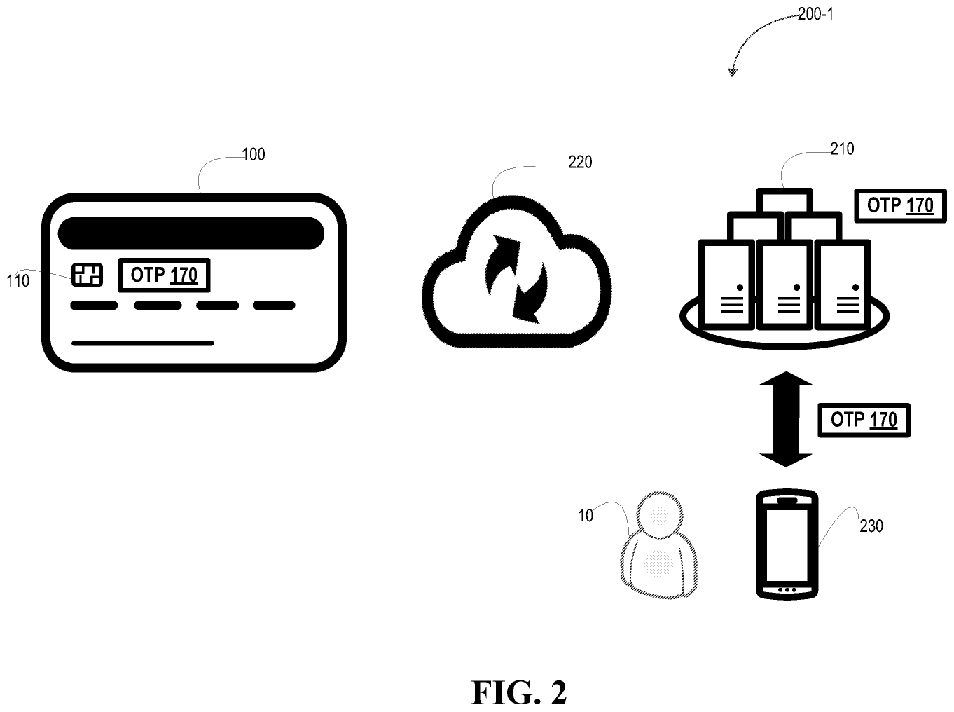

Referring to FIGS. 2, 3 and 4, shown are various embodiments of a system 200 using the OTP 170 generated by the resource distribution card device 100 for purposes of multi-factor authentication of a user 10, in accordance with embodiments of the present invention. As shown in FIG. 2, the system 200-1 includes resource distribution card device 100 having a microprocessor 110 that is configured to generate an OTP 170. The system additionally includes backend computing platform 210, which may comprise one or more authentication services, cloud services, VPN services or the like. In accordance with the system 200-1 depicted in FIG. 2, resource distribution card device 100 is in time-based synchronization 220 with backend computing platform 210. In this regard, both the microprocessor 110 of resource distribution device 100 and the backend-computing platform include timing mechanisms (e.g., clocks or the like) (not shown in FIG. 2). Synchronization 220 provides for simultaneous generation of the same OTP at both the resource distribution card device 100 and the backend computing platform 210. The OTP that is generated is generally time dependent, meaning that is usefulness for purposes of authentication is for a limited predetermined time period (e.g., sixty second or less), at which time a subsequent OTP is generated.

The backend computing platform 300 is responsible for communicating the OTP 170 to the user 10 via text message, email or the like, which is received at user device 230, such as mobile communication device. The resource distribution card 100 is pre-registered with the backend computing platform 300 and, as such, the backend computing platform knows the identity of the user and at least one user communication identifier (e.g., email address, telephone number or the like). Once the user device 230 presents the OTP to the user 10, the user 10 may enter the OTP 170 at an application executing on the user device 230 or at an ancillary computing device (e.g., POS device, ATM or the like) and the entered OTP is communicated back to the backend computing system 210 for verification purposes (i.e., authenticating the user as part of the multi-factor authentication process).

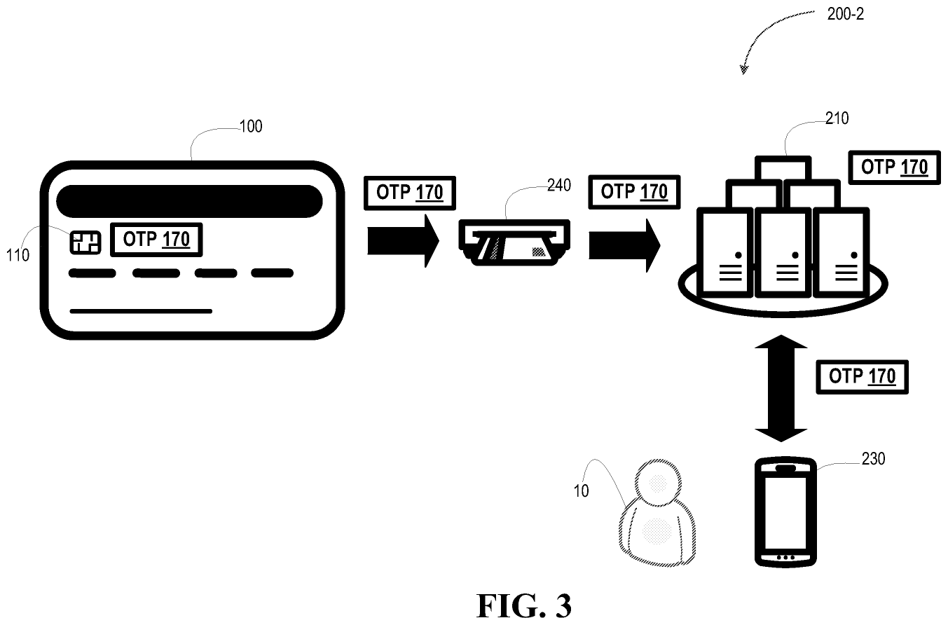

As shown in FIG. 3, the system 200-2 includes resource distribution card device 100 having a microprocessor 110 that is configured to generate an OTP 170. The system additionally includes backend computing platform 210, which may comprise one or more authentication services, cloud services, VPN services or the like. In accordance with the system 200-2 depicted in FIG. 3, resource distribution card device 100 is configured to indirectly communicate the OTP 170 to the backend computing platform 210 via a computing device 240 that is in communication with the resource distribution card device 100 and has communication means (e.g., Internet, cellular network or the like) to communicating with the back-end computing network 210. Computing device 240, which may be a Point-of-Sale (POS) device, Automated Teller Machine (ATM) or the like has the capability to read from the memory 120 of microprocessor 110 and, thus, is configured to read the OTP 170 from memory 120. In other embodiments of the invention, in which the microprocessor 110 of resource distribution card device 100 and the computing device 240 include Near Field Communication (NFC) capabilities, the OTP may be communicated from the resource distribution card device 100 to the computing device 240 via NFC (e.g., tapping of the card to an NFC reader disposed on a POS device or ATM). In response to reading or receiving the OTP, computing device 2430 is configured to communicate the OTP 170 to the backend computing platform 210.

In alternate embodiments of the invention, in which the resource distribution card device 100 is configured to be an active device (i.e., includes a power source), the card device 100 may be configured to transmitting data. In such embodiments of the invention, communication of the OTP 170 may occur directly from the resource distribution card device 170 to the backend computing platform 210.

Similar to the embodiment of the system 200-1 shown in FIG. 2, in the system 200-2 of FIG. 3, the backend computing platform 300 is responsible for communicating the OTP 170 to the user 10 via text message, email or the like, which is received at user device 230, such as mobile communication device. The resource distribution card 100 is pre-registered with the backend computing platform 300 and, as such, the backend computing platform knows the identity of the user and at least one user communication identifier (e.g., email address, telephone number or the like). Once the user device 230 presents the OTP to the user 10, the user 10 may enter the OTP 170 at an application executing on the user device 230 or at an ancillary computing device (e.g., POS device, ATM or the like) and the entered OTP is communicated back to the backend computing system 210 for verification purposes (i.e., authenticating the user as part of the multi-factor authentication process).

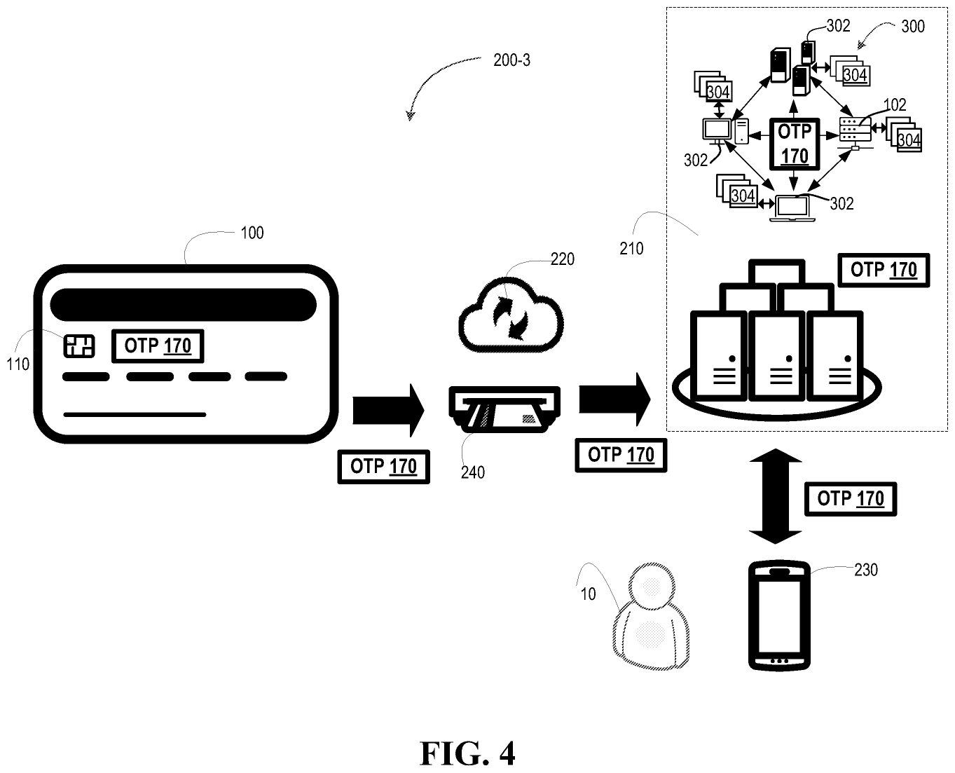

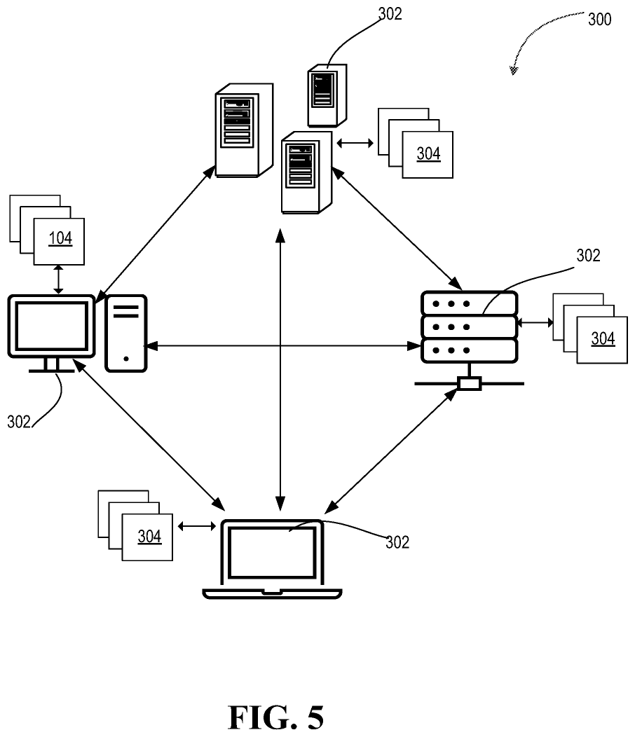

Referring to FIG. 4, system 200-3 incorporates a distributed trust computing network 300 as part of the backend computing platform 210, in accordance with embodiments of the present invention. The distributed trust computing network 300, commonly referred to as a blockchain network includes a plurality of nodes 102 storing or having access to one or more distributed ledgers 304, which are discussed in more detail in relation to FIG. 5.

The distributed trust computing network is configured to receive the OTP 170 and verify the authenticity of the OTP 170 through consensus of a plurality of the nodes 102. In response to the plurality of nodes 102 verifying the authenticity of the OTP 170, a data block (i.e., event) including the OTP and associated user data is stored within one of the one or more distributed ledgers 104.

As shown in FIG. 4, the exemplary distributed ledger technology (DLT) architecture implemented in a distributed trust computing network 300 (commonly referred to as a “blockchain” network) may refer to the protocols and supporting infrastructure that allow computing devices (peers) in different locations to propose and validate events and update records in a synchronized way across a distributed trust computing network 300. Accordingly, DLT is based on a decentralized model, in which these peers collaborate and build trust over the distributed trust computing network 300. To this end, DLT involves the use of potentially peer-to-peer protocol for a cryptographically secured distributed ledger 304 of events represented as event objects that are linked. As event objects each include information about the event object previous to it, they are linked with each additional event object, reinforcing the previously ones stored prior. Therefore, distributed ledgers are resistant to modification of their data because once recorded, the data in any given event object cannot be altered retroactively without altering all subsequent event objects.

To permit events and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or may complement a traditional text-based contract and execute certain provisions, such as conducting an event between Party A to Party B. The computer code of the smart contract itself is replicated across multiple nodes 302 (peers) and, therefore, benefits from the security, permanence, and immutability that a distributed ledger 304 offers. That replication also means that as each new event object is added to the distributed ledger 304, the code is, in effect, executed. If the parties have indicated, by initiating an event, that certain parameters have been met, the code will execute the step triggered by those parameters. If no such event has been initiated, the code will not take any steps.

Referring to FIG. 5 and as shown in the embodiment discussed in relation to FIG. 4, an exemplary distributed trust computing network 300 includes a distributed ledger 304 being maintained on multiple devices (nodes) 302 that are authorized to keep track of the distributed ledger 304. For example, the nodes 302 may be one or more computing devices such as a comprehensive computing system and one or more client device(s). Each node 302 in the distributed trust computing network 300 may have a complete or partial copy of the entire distributed ledger 304 or set of events and/or event objects (i.e., data blocks) on the distributed ledger 304. Events are initiated at a node and communicated to the various nodes in the distributed trust computing network 300. Any of the nodes 302 can validate an event, record the event to its copy of the distributed ledger 304, and/or broadcast the event, the validation of the event (in the form of an event object) and/or other data to other nodes 102. In accordance with embodiments of the present invention the event may be generation of the OTP at the resource distribution card device.

An exemplary event object includes an event header and an event object data. The event header may include a cryptographic hash of the previous event object; a nonce, i.e., a randomly generated 32-bit whole number; a cryptographic hash of the current event object wedded to the nonce; and a time stamp. The event object data may include event information (e.g., an OTP) being recorded. Once the event object is generated, the event information is considered signed and forever tied to its nonce and hash. Once generated, the event object is then deployed on the distributed ledger 104. At this time, a distributed ledger address is generated for the event object, i.e., an indication of where the event object is located on the distributed ledger 104 and captured for recording purposes. Once deployed, the event information is considered recorded in the distributed ledger 104.

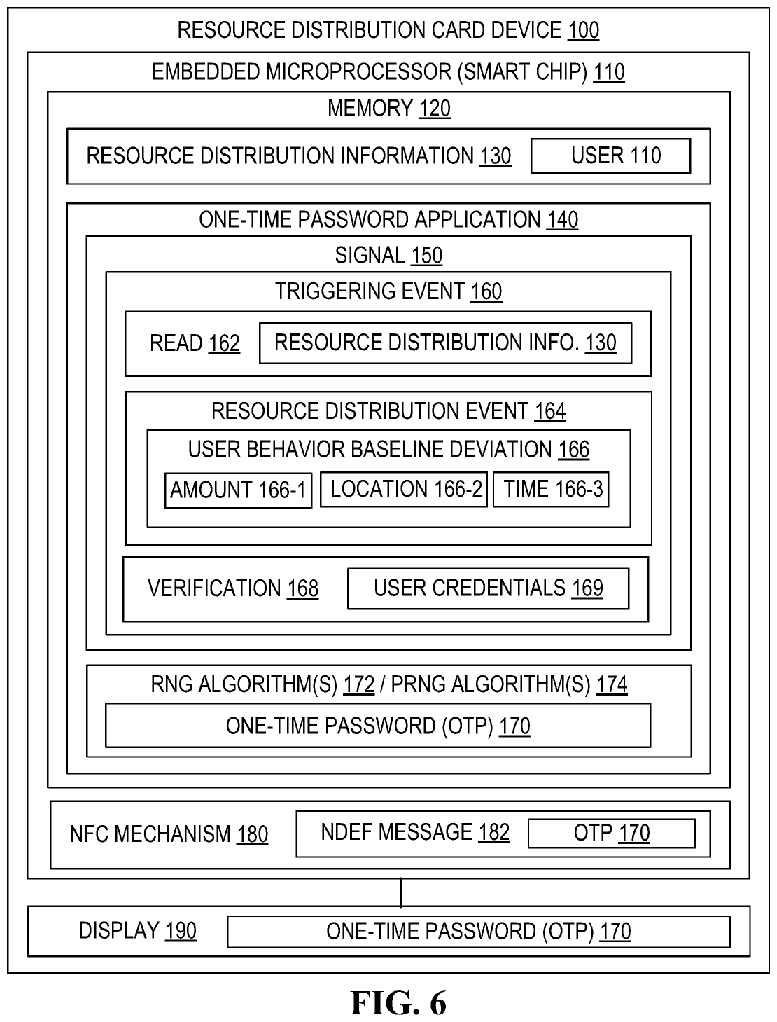

Referring to FIG. 6, a block diagram is depicted of resource distribution card device 100, in accordance with embodiments of the present invention. In addition to providing greater detail, FIG. 6 highlights various alternate embodiments of the resource card device 100. Resource computing card device 200 comprises embedded microprocessor 110, which may an EMV type chip or the like. The microprocessor 110 includes memory 120, typically random-access memory (RAM) of about 10 megabytes (MB) in size. In most embodiments of the invention, the resource distribution card device 100 is a passive device and therefore, incapable of transmitting data over the Internet, cellular networks or the like. While in other embodiments of the invention, the resource distribution card device 100 may be an active device (i.e., including a power source and transmitter (not shown in FIG. 6) for sending and receiving data via the Internet, cellular networks or the like).

As previously discussed in relation to FIG. 1, memory 120 stores resource distribution information 130 stores resource distribution information 130 associated with a card device user 10. Resource distribution information 130 is read from the memory 120 for purposes of identifying both the user 10 and the resources required to perform an associated resource distribution event for the user 10.

Memory 120 additionally stores one-time password application 140 that is configured to receive a signal 150 that notifies of an occurrence of a predetermined triggering event 160 and, in response, generate a one-time-password 170. The OTP 170 may be any numeric, alphanumeric code and/or word(s). In specific embodiments of the invention, the OTP is a numeric number and is generated using a Random Number Generator (RNG) algorithm(s) 172 or a Pseudo-Random Number Generator algorithm(s) (PRNG) 174 or the like.

The predetermined triggering event 160 may include reading 162 at least a portion of the resource distribution information 130 from the memory 120 of the microprocessor 110. Such reading 162 may occur by inserting the resource distribution card device 100 into a card reading apparatus, such as a POS device, ATM or the like or, in those embodiments of the invention in which the microprocessor 110 of the resource distribution card device 100 includes a Near Field Communication (NFC) mechanism 180, short-range wireless communication (i.e., NFC) between the resource distribution card device 100 and an NFC reader device.

In additional embodiments of the invention, the predetermined triggering event 164 may be a resource distribution event 164 (e.g., payment or withdrawal) determined, by machine learning (ML) techniques or the like, user behavior baseline deviation 166. In other words, the current resource distribution event deviates by a predetermined threshold amount from user behavior baseline (i.e., how, where and when the user typically conducts a resource distribution event). User behavior baseline deviation 166 may be based on at least one of (i) resource distribution event 164 amount 166-1, (ii) geographic or network location 166-2 of the resource distribution event 164 and/or (iii) time (e.g., time of day, week, month, year or the like) of the resource distribution event.

In other embodiments of the invention, in which the use of the OTP 170 is part of multi-factor user authentication in which the user is desiring access (i.e., access to computing network, system, application or the like or physical access to a geographic area), the predetermined triggering event 160 may be verification 168 of user credentials 169, such as username/passcode and/or biometric data (e.g., fingerprint, facial image or the like).

In alternate embodiments of the invention, microprocessor 110 of resource distribution card device 100 includes an NFC mechanism 180 that is configured to communicate the OTP 170 to a user device equipped with an NFC reader via Near field communication Data Exchange Format (NDEF) communication protocol. In such embodiments of the invention, direct communication of the OTP 170 to the user device may be the primary means of communicating the OTP 170 to the user or, in alternate specific embodiments of the invention, may be the backup means for communicating the OTP 170 in the event that the backend computing platform 210 is unavailable or communication of the OTP 170 from the backend computing platform 210 fails.

In additional specific embodiments of the invention, resource distribution card device 100 includes a display 190, such as a Light Emitting Diode (LED) display or the like, embed in the card. The display 190 is configured to display the OTP 170. In specific embodiments of the invention, the OTP 170 is only displayed if the type of the multi-factor user authentication is determined to warrant such (i.e., the authentication is not based on the user possessing the resource distribution card device 100 and another user device (e.g., mobile device) simultaneously). In such embodiments, the determination of authentication type is undertaken prior to display of the OTP 170.

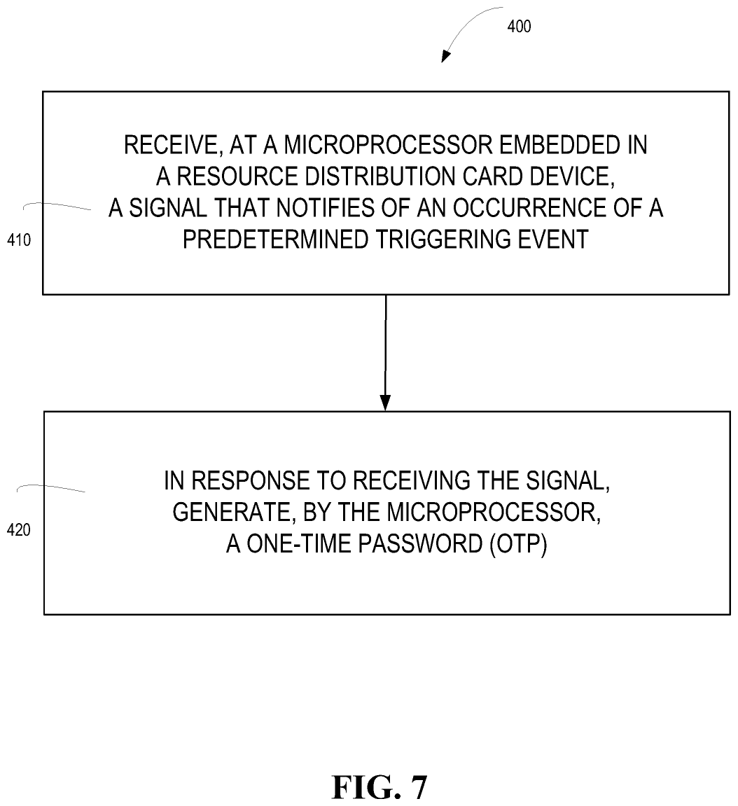

Referring to FIG. 7, a flow diagram is depicted of a method 400 for generating an OTP, in accordance with embodiments of the present invention. At Event 410, a signal is received at a microprocessor embedded in a resource distribution card device. The signal provides notification of an occurrence of a predetermined triggering event. As previously discussed, the predetermined triggering event may include, but is not limited to, (i) reading at least a portion of the resource distribution information stored in the memory, (ii) using the resource distribution card to initiate a resource distribution event that is determined to deviate from a known user behavior baseline for resource distribution events, and (iii) verification of user inputted user credentials, such as username/passcode, biometric data or the like.

In response to receiving the signal, at Event 420, a One-Time Password (OTP) is generated by the microprocessor/smart chip of the resource distribution card device. In specific embodiments of the invention, synchronization between the resource distribution card device and a backend computing platform results in simultaneous generation of the OTP at the card device and the backend computing platform. In other embodiments of the invention, the OTP is subsequently communicated, either indirectly or directly, to the backend computing platform.

Thus, present embodiments of the invention provide devices, methods, computer program products and/or the like for a resource distribution card device that includes a microprocessor (i.e., smart chip) that is capable of generating a One Time Passcode (OTP). The resource distribution card acts as a hardware token that is capable of generating an OTP. An OTP application stored within the memory of the microprocessor receives a signal that notifies of an occurrence of a predetermined triggering event and, in response to receiving the signal, generates an OTP, which is either simultaneously generated at a backend computing platform via time-based synchronization or indirectly communicated to the backend computing platform, which communicates the OTP to the user and performs requisite verification as part of a multi-factor user authentication process.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A resource distribution card device for initiating multi-factor user authentication, the device comprising:
an embedded microprocessor that includes a memory, wherein the memory stores resource distribution information associated with a user and a One-Time Password (OTP) application that is executable by the microprocessor and configured to:
receive a signal that notifies of an occurrence of a predetermined triggering event, and
in response to receiving the signal, generate an OTP,
wherein the OTP is used as part of a multi-factor authentication of the user.

2. The resource distribution card device of claim 1, wherein the OTP application stored within the memory of the embedded microprocessor includes at least one Random Number Generator (RNG) algorithm configured to, in response to receiving the signal, generate the OTP.

3. The resource distribution card device system of claim 1, wherein the resource distribution card device is pre-registered with an OTP module executing on a backend-computing platform, wherein pre-registering includes associating a user and at least one user communication identifier with the OTP application of the resource distribution card device, and wherein the OTP application is synchronized with an OTP module for purposes of OTP generation.

4. The resource distribution card device of claim 1, wherein the OTP application is configured to receive the signal that notifies of the occurrence of the predetermined triggering event, wherein the predetermined triggering event is the reading at least a portion of the resource distribution information stored in the memory.

5. The resource distribution card device of claim 1, wherein the embedded microprocessor includes a Near Field Communication (NFC) mechanism, and wherein the OTP application is configured to receive the signal that notifies of the occurrence of the predetermined triggering event, wherein the predetermined triggering event is activating the NFC mechanism to transmit the resource distribution information stored in the memory.

6. The resource distribution card device of claim 1, wherein the OTP application is configured to receive the signal that notifies of the occurrence of the predetermined triggering event, wherein the predetermined triggering event is a resource distribution event initiated by the resource distribution card that is determined to deviate from a known user baseline for resource distribution events.

7. The resource distribution card device of claim 6, wherein the OTP application is configured to receive the signal that notifies of the occurrence of the predetermined triggering event, wherein the predetermined triggering event is the resource distribution event that is determined to deviate from the known user baseline for resource distribution events, wherein the known user baseline is based on at least one of (i) amount of the resource distribution event, (ii) location of the resource distribution event, and (iii) time of the resource distribution event.

8. The resource distribution card device of claim 1 wherein the OTP application is configured to receive the signal that notifies of the occurrence of the predetermined triggering event, wherein the predetermined triggering event is verification of user credentials an input from the user to the user input device.

9. The resource distribution card device of claim 1, wherein the resource distribution card device further includes a display in communication with the embedded microprocessor wherein the display is configured to, in response to generating the OTP, display the OTP.

10. The resource distribution card device of claim 1, wherein the OTP application is further configured to initiate indirect transmission of the OTP to an OTP module executing on a back-end computing platform, wherein the OTP module is configured to:
store an association between the OTP and at least one of the (i) user, and (ii) a pre-registered user communication identifier.

11. The resource distribution card device of claim 10, wherein the OTP module is further configured to communicate the OTP to the user based on the pre-registered user communication identifier.

12. The resource distribution card device of claim 1, wherein the embedded microprocessor further includes a Near Field Communication (NFC) mechanism, and wherein the OTP application is configured to directly communicate the generated OTP from the resource distribution card device to a user device associated with the user and equipped with an NFC reader via an NFC Data Exchange Format (NDEF) message.

13. The resource distribution card device of claim 1, wherein the OTP is communicated the OTP to a distributed trust computing network comprising a plurality of decentralized nodes,
wherein the OTP is received by the distributed trust computing network and a plurality of the decentralized nodes are configured to verify an authenticity of the OTP and, in response, store the OTP and association data as a data block within a distributed ledger.

14. A computer-implemented method for initiating multi-factor user authentication, the computer-implemented method is executable by one or more computing processor devices, the method comprising:
receiving, at a microprocessor embedded in a resource distribution card device, a signal that notifies of an occurrence of a predetermined triggering event;
in response to receiving the signal, generating, by the microprocessor, a One-Time Password (OTP),
wherein the OTP is used as part of a multi-factor authentication of the user.

15. The computer-implemented method of claim 14, further comprising:
initiating indirect transmission of the OTP to a back-end computing platform;
in response to receiving the OTP at the back-end-computing platform, storing an association between the OTP and at least one of the (i) user, and (ii) a pre-registered user communication identifier; and
communicating the OTP from the back-end computing platform to the user based on the pre-registered user communication identifier.

16. The computer-implemented method of claim 14, wherein the resource distribution card device is pre-registered with an OTP module executing on a backend-computing platform, wherein pre-registering includes associating the user and at least one user communication identifier with the OTP application of the resource distribution card device, and wherein the OTP application is synchronized with an OTP module for purposes of OTP generation.

17. The computer-implemented method of claim 14, wherein the predetermined triggering event is selected from the group consisting of (i) reading at least a portion of the resource distribution information stored in the memory, (ii) using the resource distribution card to initiate a resource distribution event that is determined to deviate from a known user baseline for resource distribution events, and (iii) verification of user inputted user credentials.

18. A computer program product comprising:
a non-transitory computer-readable medium comprising:
a first set of codes for causing a microprocessor embedded in a resource distribution card device to receive a signal that notifies of an occurrence of a predetermined triggering event;
a second set of codes for causing the microprocessor to generate a One-Time Password (OTP),
wherein the OTP is used as part of a multi-factor authentication of the user.

19. The computer program product of claim 18, wherein the sets of codes further comprise:
a third set of codes for causing the microprocessor to initiate indirect transmission of the OTP to a back-end computing platform;
a fourth set of codes for causing a computing device to, in response to receiving the OTP at the back-end-computing platform, storing an association between the OTP and at least one of the (i) user, and (ii) a pre-registered user communication identifier; and
a fifth set of codes for causing a computing device to communicate the OTP to the user from the back-end computing platform based on the pre-registered user communication identifier

20. The computer program product of claim 18, wherein the resource distribution card device is pre-registered with an OTP module executing on a backend-computing platform, wherein pre-registering includes associating the user and at least one user communication identifier with the OTP application of the resource distribution card device, and wherein the OTP application is synchronized with an OTP module for purposes of OTP generation.
